(19) United States
(12) Patent Application Publication
(10) Pub. No.: US 2023/0342644 A1
(43) Pub. Date: Oct. 26, 2023

(54) METHOD FOR ENHANCED SAMPLING FROM A PROBABILITY DISTRIBUTION

(71) Applicant: Multiverse Computing, S.L., Donostia-San Sebastian (ES)

(72) Inventors: Román ORÚS, Donostia-San Sebastian (ES); Samuel MUGEL, Toronto (CA); Saeed JAHROMI, Donostia-San Sebastian (ES)

(21) Appl. No.: 17/729,585

(22) Filed: Apr. 26, 2022

(51) Int. Cl. G06N 7/00

(52) U.S. Cl. CPC G06N 7/005

(57) ABSTRACT

A computer-implemented method including: receiving data including a probability distribution of a dataset or a multivariate probability distribution about a target, the probability distribution relating to a plurality of discrete random variables; providing a tensor codifying the probability distribution such that each configuration of the plurality of discrete random variables has its respective probability codified therein; encoding the tensor into a tensor network in the form of a matrix product state, where an external index of each tensor of the tensor network represents one discrete random variable of the plurality discrete random variables, and an internal index or internal indices of each tensor of the tensor network represents correlation between the tensor and the corresponding adjacent tensor of the tensor network; and computing at least one moment of the probability distribution by processing the tensor network for sampling of the probability distribution.

### TECHNICAL FIELD

The present disclosure relates to the field of computing devices. More concretely, the disclosure relates to computing devices configured as probability samplers that encode a probability distribution into a tensor network.

### BACKGROUND

Sampling from a probability distribution is one way of determining how some machine, system or process behaves in many fields like, for instance, chemistry, telecommunications, cryptography, physics, etc.

Sampling techniques based on Monte Carlo approach are ones of the most widely used sampling techniques in many situations due to their characteristics, as they are useful for targets having many variables that may be coupled one to another. Monte Carlo techniques generate random samples with a uniform distribution; a targeted probability distribution can then be provided based on the resulting samples, which may be first evaluated to use the samples or not according to conditions that may be set, like the detailed-balance condition.

A variant of a technique relying on Monte Carlo is Markov Chain MC that establishes that each new sample is only correlated with the previous sample. That, in turn, requires generating a large number of samples, from which a portion cannot be used and, hence, are to be removed because they do not satisfy one or more conditions, like the detailed-balance and/or the ergodicity condition. The Markov Chain MC has its limitations, one of which is that it cannot be guaranteed that the samples in the distribution are uncorrelated.

Lack of uncorrelation means that the sampling will not accurately represent the behavior of the target associated with the probability distribution. As such, any determination made from the sampling will not be based upon a proper sampling and, worse, any decision made from the determination might not be the most appropriate.

It would be convenient to have a method for sampling that solves the shortcomings of techniques as described above.

### SUMMARY

A first aspect of the disclosure relates to a computer-implemented method for sampling. The method includes: receiving data including a probability distribution about a target, the probability distributing being of a dataset or a multivariate probability distribution, the probability distribution relating to a plurality of discrete random variables; providing a tensor codifying the probability distribution such that each configuration of the plurality of discrete random variables has its respective probability codified therein, where all probabilities are greater than or equal to zero and a sum of all probabilities is equal to one; encoding the tensor into a tensor network in the form of a matrix product state, where an external index of each tensor of the tensor network represents one discrete random variable of the plurality discrete random variables, and an internal index or internal indices of each tensor of the tensor network represents correlation between the tensor and the corresponding adjacent tensor of the tensor network; and computing at least one moment of the probability distribution by processing the tensor network for sampling of the probability distribution. The target is one of a process, a machine and a system.

The probability distribution represents different probabilities about the target, which has the plurality of discrete random variables defining the behavior or operation of the target. The probabilities can be set by way of a model of the target (e.g. a mathematical model describing the behavior or operation of the target with probability distributions) or by performing experimental tests that make possible to determine probabilities of occurrence of certain events.

The probability distribution is included in the tensor provided, which is a probability tensor. Accordingly, the configurations of the discrete random variables, with respective probabilities thereof, are defined in the tensor. That way, the tensor includes all the information about the probability distribution so that data is extracted from the probability distribution by operating with the tensor.

For effective sampling from the probability distribution, the tensor is transformed into a tensor network of a matrix product state, MPS. As known in the art, the tensors of an MPS have an external index, and one or two internal indices, depending on whether the tensor is at an end of the MPS or not. The external index, also referred to as physical dimension, of each tensor is representative of a respective discrete random variable, hence the MPS has as many tensors as discrete random variables are in the probability distribution. Further, the internal index or indices, also referred to as virtual dimension or dimensions, are representative of the correlation between adjacent tensors.

By operating the tensor network as known in the art, different data can be sampled from the probability distribution since it is encoded in the tensor network itself. Depending on the moment or moments computed, a different type of value is sampled, e.g. the expected value, the variance, the skewness, etc.

In some embodiments, a simple manner for encoding the tensor into the tensor network can be conducted by factorizing the tensor into the tensors of the tensor network by processing the tensor so that the following equation is solved:

P=T/Z_{T}
where P is the resulting normalized factorization into the tensors of the tensor network, T is the encoded tensor, i.e. the probability tensor, and Z_{T} is a predetermined normalization factor Z_{T}=Σx₁, . . . , x_{N} T_{X}_{₁}, . . . , x_{N}, with X₁, . . . , x_{N} being respective N configurations of the plurality of discrete random variables of the probability distribution, T_{X}_{₁}, . . . , x_{N} being the tensor for the respective configuration, and N being the number of discrete random variables in the plurality of discrete random variables. It is noted that P is the normalized factorization owing to Z_{T}; the factor Z_{T} is such that the probabilities in P add up to 1.

In some embodiments, encoding the tensor into the tensor network further includes minimizing the following negative log-likelihood, NLL, function for each sample xᵢ of a discrete multivariate distribution:

$$L = - {\sum }_{i} log ( {T}_{{x}_{i}} / {Z}_{T} )$$

where each sample xᵢ has values for each of the discrete random variables, i.e. {xᵢ=(X₁ᵢ, . . . , X_{Ni})}, and T_{X}_{ᵢ} is the tensor for the sample xᵢ.

The probability distribution is encoded into the tensor network following a machine learning approach whereby, preferably in a plurality of iterations, the tensor network is provided as an approximation of the probability distribution as a result of the minimization of the NLL function. This technique progressively performs the approximation, which can be made more accurate by making the minimization more iterations, thus a trade-off can be established regarding the accuracy of the approximation and the time it takes to provide the tensor network.

In some embodiments, the minimization of the negative log-likelihood function for each sample xᵢ is calculated with local gradient-descent in which the gradient of the function is computed for all tensors of the tensor network.

By iteratively calculating the local gradient-descent as follows, the minimization of the NLL function is progressively achieved:

$${\partial }_{ω} L = - {\sum }_{i} \frac{{\partial }_{ω} {{T}_{x}}_{i}}{{T}_{{x}_{i}}} - \frac{{\partial }_{ω} {Z}_{T}}{{Z}_{T}}$$

In some embodiments, encoding the tensor into the tensor network further includes compressing a probability mass function into a tensor that is not negative, and minimizing the following Kullback-Leibler divergence equation:

$$D ( P \vert \vert T / {Z}_{T} ) = {\sum }_{{X}_{1} , … , {X}_{N}} {P}_{{X}_{1} , … , {X}_{N}} log ( \frac{{P}_{{X}_{1} , … , {X}_{N}}}{{T}_{{X}_{1} , … , {X}_{N}} / {Z}_{T}} )$$

where P_{X}_{₁}, . . . , x_{N} is the probability mass function corresponding to the probability distribution.

The tensor network can be trained with the provided tensor to encode the probability distribution therein. In this sense, the probability distribution is approximated by making the compression of the probability mass function into the tensor.

In some embodiments, the received probability distribution is generated by a probability mass function.

In some embodiments, the method further includes, after the step of computing, providing a predetermined command at least based on the computed at least one moment.

As a result of the sampling, it may be determined that the target is prone to or is experiencing a faulty behavior or operation. Based on that determination, it may be decided, preferably automatically, whether to run one or more commands intended to address the situation. For example, a determined situation may have to be logged, or notified to a device so that a decision may be made manually, or the target be controlled with one or more commands to change an operation thereof.

In some embodiments, the predetermined command includes one or both of: providing a notification indicative of the computed at least one moment to an electronic device; and providing a command to a controlling device or system associated with the target or to the target itself when the target is either a machine or a system, the command being for changing a behavior of the target.

In some embodiments, computing the at least one moment includes computing any one of the first, second, third and fourth moments of the probability distribution by processing the tensor network.

In some embodiments, computing the at least one moment includes computing a contraction of the tensor network.

Tensor contraction can be computed in several ways, one of which being that disclosed in patent application U.S. Ser. No. 17/563,377, which is incorporated by reference in its entirety. The contraction of the tensor network can provide expected values of the probability distribution.

In some embodiments, the target includes one of: an electrical grid, an electricity network (e.g. of a building, of a street, of a neighborhood, etc.), a portfolio of financial derivatives, a system of devices and/or machines (e.g. of a factory, of an industrial installation, etc.), or a set of patients of a hospital unit (e.g. intensive care unit, non-intensive care unit, etc.).

By way of example: when the target relates to the electrical grid or electricity network, the sampling may be for stochastic optimization of the energy markets, or for probabilistic predictive maintenance of the different devices of the grid/network; when the target relates to a portfolio of financial derivatives, the sampling may be for pricing or deep hedging; when the target relates to the system of devices and/or machines, the sampling may be for probabilistic predictive maintenance of the devices/machines; and when the target relates to the set of patients, the sampling may be for probabilistic prediction of evolution of the patients.

For instance, the samples of the distribution that may be fed to the sampling technique might be measurements from a plurality of measurements of the devices and/or machines of the system that measure the behavior or operating condition thereof, or measurements of the patients (with e.g. biosensors). The sampling then provides, for instance, data indicative of the probability that a device or machine will malfunction in a predetermined time horizon (e.g. one hour, ten hours, one day, etc.), or indicative of the probability that a patient will suffer a seizure or crisis in a predetermined time horizon (e.g. half hour, one hour, three hours, etc.).

Samples of the distribution can be obtained, for example but without limitation, from existing mathematical models or algorithms describing the behavior of the target, from historical data with actual measurements or information, etc. By way of example, when the target comprises a set of patients, the samples can be historical data and/or statistics of patients having particular health conditions that have suffered seizures or crisis after one or several situations have taken place (e.g. particular drugs being supplied to the patients, increasing heart rate, fever, etc.). As another example, in the case of the target comprising the system, the samples can be probabilities of devices/machines malfunctioning in determined conditions.

A second aspect of the disclosure relates to a data processing device or system including means for carrying out the steps of a method according to the first aspect.

In some embodiments, the device or system further includes the target.

In some embodiments, the device or system further includes a quantum device.

A third aspect of the disclosure relates to a device or system including: at least one processor, and at least one memory including computer program code for one or more programs; the at least one processor, the at least one memory, and the computer program code configured to cause the device or system to at least carry out the steps of a method according to the first aspect.

A fourth aspect of the disclosure relates to a computer program product including instructions which, when the program is executed by a computer, cause the computer to carry out the steps of a method according to the first aspect.

A fifth aspect of the disclosure relates to a non-transitory computer-readable medium encoded with instructions that, when executed by at least one processor or hardware, perform or make a device to perform the steps of a method according to the first aspect.

A sixth aspect of the disclosure relates to a computer-readable data carrier having stored thereon a computer program product according to the fourth aspect.

Similar advantages as those described with respect to the first aspect of the disclosure also apply to the remaining aspects of the disclosure.

### BRIEF DESCRIPTION OF THE DRAWINGS

To complete the description and in order to provide for a better understanding of the disclosure, a set of drawings is provided. Said drawings form an integral part of the description and illustrate embodiments, which should not be interpreted as restricting the scope of the disclosure, but just as examples of how the disclosed methods or entities can be carried out.

The drawings comprise the following figures:

FIG. 1 diagrammatically shows a computing apparatus or system 10 in accordance with some embodiments.

FIG. 2 shows a tensor as provided in methods in accordance with some embodiments.

FIG. 3 shows a tensor network as provided in methods in accordance with some embodiments.

FIG. 4 shows a method for sampling from a probability distribution in accordance with some embodiments.

FIGS. 5 and 6 show steps for encoding a tensor into a tensor network as carried out in methods in accordance with some embodiments.

### DESCRIPTION OF EMBODIMENTS

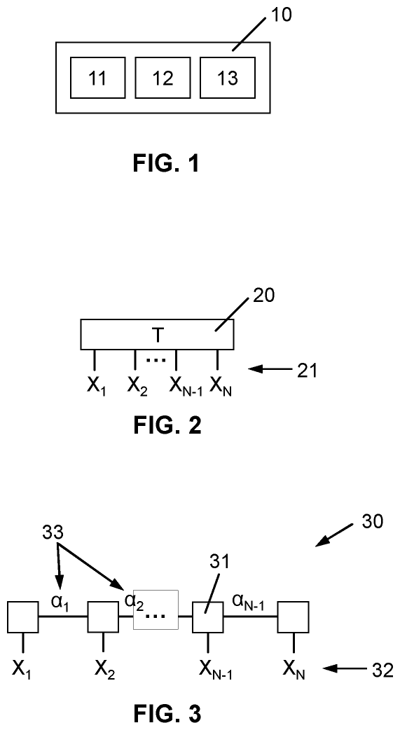

FIG. 1 diagrammatically shows a computing apparatus or system 10 in accordance with embodiments. Methods according to the present disclosure can be carried out by such an apparatus or system 10.

The apparatus or system 10 comprises at least one processor 11, namely at least one classical processor, at least one memory 12, and a communications module 13 at least configured to receive data from and transmit data to other apparatuses or systems in wired or wireless form, thereby making possible to e.g. receive probability distributions in the form of electrical signals, either in analog form, in which case the apparatus or system 10 digitizes them, or in digital form. The probability distributions can be received from e.g. the target related to the probability distributions, a controlling device or system thereof, or another entity like a server or network having the probability distributions about the target.

FIG. 2 shows a tensor 20 as provided in methods in accordance with some embodiments.

The tensor 20 is regarded as a probability tensor that has a probability distribution codified therein. In this sense, legs 21 of the tensor are discrete random variables (labeled from X₁ to X_{N}) of the probability distribution, therefore there are as many legs 21 as discrete random variables are, in this case N.

FIG. 3 shows a tensor network 30 as provided in methods in accordance with some embodiments.

The tensor network 30, particularly an MPS, is provided upon conversion of a probability tensor, like the one shown in FIG. 2, into the MPS. The tensor network 30 has a plurality of tensors 31, label from A₁ to A_{N}, which has as many tensors as discrete random variables the probability distribution has.

Each tensor of the tensor network 30 has one external index 32, which is the discrete random variable that the tensor corresponds to, also labeled from X₁ to X_{N}. Further, the correlation between adjacent tensors 31 is given by the internal index or indices 33, which are labeled from α₁ to α_{N-1}. By controlling the internal indices 33, the correlation or, alternatively, the compression of the data between adjacent tensors can be controlled. The alpha parameter, a, sets how much of the most relevant data between the adjacent tensors is to be maintained, so once a probability tensor has been encoded into the tensor network 30, adjustments to the internal indices 33 will change the accuracy of the approximation of the original probability distribution in the network 30.

The factorization of a tensor like that of FIG. 2 into the tensor network of FIG. 3 can also be represented with the following equation:

$${T}_{{X}_{1} , … , {X}_{N}} = {\sum }_{( {α}_{i} = 1 )}^{r} {A}_{1 , {X}_{1}}^{{α}_{1}} {A}_{2 , {X}_{2}}^{{α}_{1} , {α}_{2}} … {A}_{N - 1 , {X}_{N - 1}}^{{α}_{N - 2} {α}_{N - 1}} {A}_{N , {X}_{N}}^{{α}_{N - 1}}$$

with T_{X}_{₁}, . . . , x_{N} being the probability tensor, e.g. the tensor 20 of FIG. 2.

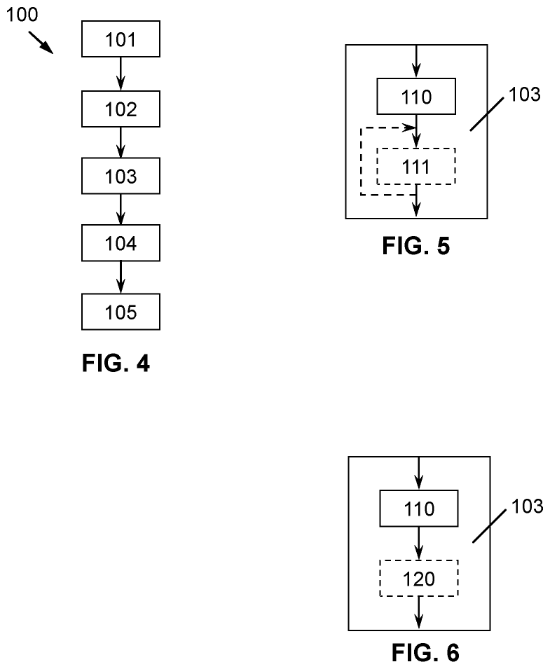

FIG. 4 shows a method 100 for sampling from a probability distribution in accordance with some embodiments.

The method 100, which is a computer-implemented method run in one or more processors, comprises a step 101 whereby the one or more processors receive data including a probability distribution of a dataset or a multivariate probability distribution about a target. The probability distribution is associated with a plurality of discrete random variables. Each random variable can take up to D different discrete values.

The method 100 further comprises a step 102 whereby the one or more processors provide a tensor, like that of FIG. 2, with the received 101 probability distribution codified therein. Particularly, the different values of the tensor are the probabilities of the configurations of the plurality of discrete random variables. Since the tensor includes probabilities of a probability distribution, they all are between zero and one, and the sum thereof is one.

In a subsequent step 103 of the method 100, the one or more processors encode the provided 102 tensor into a tensor network, like in FIG. 3. Particularly, the tensor network has tensors such that it forms a matrix product state, MPS. As seen in FIG. 3, the external index of the tensors represents one of the N discrete random variables, and the internal index or indices of the tensors represent correlation between the tensor and the respective adjacent tensor.

The method 100 further comprises a step 104 whereby the one or more processors sample the probability distribution. To perform the sampling, the one or more processors process the encoded 103 tensor network to compute one or more moments of the probability distribution.

The method 100 also comprises, in some embodiments like those of FIG. 4, another step 105 whereby the one or more processors provide a predetermined command based on the sampling 104.

FIG. 5 shows steps 110, 111 for encoding a tensor into a tensor network as carried out in methods in accordance with some embodiments.

The steps 110, 111 are part of the step of encoding 103 the tensor into a tensor network, namely, of encoding 103 the probability distribution in the tensor into the tensor network.

In the first step 110, the tensor is factorized into the tensors of the tensor network by processing the following equation:

P=T/Z_{T}
with P being the resulting normalized factorization, T the encoded tensor, and Z_{T} the predetermined normalization factor. Accordingly, a tensor network like that shown in FIG. 3 can be provided from a tensor like that shown in FIG. 2.

For a more accurate approximation of the probability distribution in the tensor network, in some embodiments (as illustratively represented with dashed lines for the sake of clarity only) the second step 111 is also conducted. In said step 111, the NLL function is minimized considering samples xᵢ for the probability distribution each sample xᵢ, preferably with local gradient-descent. The minimization is preferably conducted a plurality of times as shown with a dashed line for illustrative purposes only.

FIG. 6 shows steps 110, 120 for encoding a tensor into a tensor network as carried out in methods in accordance with some embodiments.

The steps 110, 120 are part of the step of encoding 103 the tensor into a tensor network, with step 110 being the same as that described with reference to FIG. 5.

In some embodiments, subsequent to step 110 is step 120 whereby the processor(s) compresses a probability mass function into a non-negative tensor, and minimizes the Kullback-Leibler divergence equation.

It will be noted that the steps shown with reference to FIGS. 5 and 6 are present in some embodiments only, hence methods according to embodiments as described in FIG. 4 do not necessarily include the steps of either FIG. 5 or FIG. 6.

In this text, the terms “includes”, “comprises”, and their derivations—such as “including”, “comprising”, etc.—should not be understood in an excluding sense, that is, these terms should not be interpreted as excluding the possibility that what is described and defined may include further elements, steps, etc.

On the other hand, the disclosure is obviously not limited to the specific embodiment(s) described herein, but also encompasses any variations that may be considered by any person skilled in the art—for example, as regards the choice of materials, dimensions, components, configuration, etc.—, within the general scope of the disclosure as defined in the claims.

1. A device or system comprising:
at least one processor; and
at least one memory comprising computer program code for one or more programs;
the at least one processor, the at least one memory, and the computer program code being configured to cause the device or system to at least carry out the following:
receiving data including a probability distribution of a dataset or a multivariate probability distribution about a target, the probability distribution relating to a plurality of discrete random variables;
providing a tensor codifying the probability distribution such that each configuration of the plurality of discrete random variables has its respective probability codified therein, where all probabilities are greater than or equal to zero and a sum of all probabilities is equal to one;
encoding the tensor into a tensor network in the form of a matrix product state, where an external index of each tensor of the tensor network represents one discrete random variable of the plurality discrete random variables, and an internal index or internal indices of each tensor of the tensor network represents correlation between the tensor and the corresponding adjacent tensor of the tensor network; and
computing at least one moment of the probability distribution by processing the tensor network for sampling of the probability distribution.

2. The device or system of claim 1, wherein the at least one processor, the at least one memory, and the computer program code are configured to further cause the device or system to at least carry out the following: providing a predetermined command at least based on the computed at least one moment.

3. The device or system of claim 2, wherein the predetermined command comprises one or both of: providing a notification indicative of the computed at least one moment to an electronic device; and providing a command to a controlling device or system associated with the target or to the target itself when the target is either a machine or a system, the predetermined command being for changing a behavior of the target.

4. The device or system of claim 1, wherein encoding the tensor into the tensor network comprises factorizing the tensor into the tensors of the tensor network by processing the tensor so that the following equation is solved:
P=T/Z_{T}
where P is the resulting normalized factorization into the tensors of the tensor network, T is the encoded tensor, and Z_{T} is a predetermined normalization factor Z_{T}=ΣX₁, . . . , x_{N} T_{X}_{₁}, . . . , x_{N}, with X₁, . . . , X_{N} being respective N configurations of the plurality of discrete random variables of the probability distribution, T_{X}_{₁}, . . . , x_{N} being the tensor for the respective configuration, and N being the number of discrete random variables in the plurality of discrete random variables.

5. The device or system of claim 4, wherein encoding the tensor into the tensor network further comprises minimizing the following negative log-likelihood function for each sample xᵢ of a discrete multivariate distribution:
$$L = - {\sum }_{i} log ( {T}_{{x}_{i}} / {Z}_{T} )$$
where each sample xᵢ has values for each of the discrete random variables, and T_{X}_{ᵢ} is the tensor for the sample xᵢ.

6. The device or system of claim 5, wherein the minimization of the negative log-likelihood function for each sample xᵢ is calculated with local gradient-descent in which the gradient of the function is computed for all tensors of the tensor network.

7. The device or system of claim 6, wherein values of the tensors of the tensor network are modified iteratively to approximate the probability distribution therein.

8. The device or system of claim 4, wherein encoding the tensor into the tensor network further comprises compressing a probability mass function into a tensor that is not negative, and minimizing the following Kullback-Leibler divergence equation:
$$D ( P \vert \vert T / {Z}_{T} ) = {\sum }_{{X}_{1} , … , {X}_{N}} {P}_{{X}_{1} , … , {X}_{N}} log ( \frac{{P}_{{X}_{1} , … , {X}_{N}}}{{T}_{{X}_{1} , … , {X}_{N}} / {Z}_{T}} )$$
where P_{X}_{₁}, . . . , x_{N} is a probability mass function corresponding to the probability distribution.

9. The device or system of claim 1, wherein computing the at least one moment comprises computing any one of the first, second, third and fourth moments of the probability distribution by processing the tensor network.

10. The device or system of claim 1, wherein computing the at least one moment comprises computing a contraction of the tensor network.

11. The device or system of claim 1, wherein the target comprises: an electrical grid, an electricity network, a portfolio of financial derivatives, a stock market, a set of patients of a hospital unit, or a system comprising one of: one or more devices, one or more machines, or a combination thereof.

12. A computer-implemented method, comprising:
receiving data including a probability distribution of a dataset or a multivariate probability distribution about a target, the probability distribution relating to a plurality of discrete random variables;
providing a tensor codifying the probability distribution such that each configuration of the plurality of discrete random variables has its respective probability codified therein, where all probabilities are greater than or equal to zero and a sum of all probabilities is equal to one;
encoding the tensor into a tensor network in the form of a matrix product state, where an external index of each tensor of the tensor network represents one discrete random variable of the plurality discrete random variables, and an internal index or internal indices of each tensor of the tensor network represents correlation between the tensor and the corresponding adjacent tensor of the tensor network; and
computing at least one moment of the probability distribution by processing the tensor network for sampling of the probability distribution.

13. The computer-implemented method of claim 12, further comprising, after the step of computing, providing a predetermined command at least based on the computed at least one moment.

14. The computer-implemented method of claim 12, wherein the predetermined command comprises one or both of: providing a notification indicative of the computed at least one moment to an electronic device; and providing a command to a controlling device or system associated with the target or to the target itself when the target is either a machine or a system, the command being for changing a behavior of the target.

15. The computer-implemented method of claim 12, wherein encoding the tensor into the tensor network comprises factorizing the tensor into the tensors of the tensor network by processing the tensor so that the following equation is solved:
P=T/Z_{T}
where P is the resulting normalized factorization into the tensors of the tensor network, T is the encoded tensor, and Z_{T} is a predetermined normalization factor Z_{T}=Σ_{X}_{₁}, . . . , x_{N} T_{X}_{₁}, . . . , x_{N}, with X₁, . . . , X_{N} being respective N configurations of the plurality of discrete random variables of the probability distribution, T_{X}_{₁}, . . . , x_{N} being the tensor for the respective configuration, and N being the number of discrete random variables in the plurality of discrete random variables.

16. The computer-implemented method of claim 15, wherein encoding the tensor into the tensor network further comprises minimizing the following negative log-likelihood function for each sample xᵢ of a discrete multivariate distribution:
$$L = - {\sum }_{i} log ( {T}_{{x}_{i}} / {Z}_{T} )$$
where each sample xᵢ has values for each of the discrete random variables, and T_{X}_{ᵢ} is the tensor for the sample xᵢ.

17. The computer-implemented method of claim 16, wherein the minimization of the negative log-likelihood function for each sample xᵢ is calculated with local gradient-descent in which the gradient of the function is computed for all tensors of the tensor network.

18. The computer-implemented method of claim 17, wherein values of the tensors of the tensor network are modified iteratively to approximate the probability distribution therein.

19. The computer-implemented method of claim 15, wherein encoding the tensor into the tensor network further comprises compressing a probability mass function into a tensor that is not negative, and minimizing the following Kullback-Leibler divergence equation:
$$D ( P \vert \vert T / {Z}_{T} ) = {\sum }_{{X}_{1} , … , {X}_{N}} {P}_{{X}_{1} , … , {X}_{N}} log ( \frac{{P}_{{X}_{1} , … , {X}_{N}}}{{T}_{{X}_{1} , … , {X}_{N}} / {Z}_{T}} )$$
where P_{X}_{₁}, . . . x_{N} is a probability mass function corresponding to the probability distribution.

20. A non-transitory computer-readable medium encoded with instructions that, when executed by at least one processor or hardware, perform or make a device to at least perform the following steps:
receiving data including a probability distribution of a dataset or a multivariate probability distribution about a target, the probability distribution relating to a plurality of discrete random variables;
providing a tensor codifying the probability distribution such that each configuration of the plurality of discrete random variables has its respective probability codified therein, where all probabilities are greater than or equal to zero and a sum of all probabilities is equal to one;
encoding the tensor into a tensor network in the form of a matrix product state, where an external index of each tensor of the tensor network represents one discrete random variable of the plurality discrete random variables, and an internal index or internal indices of each tensor of the tensor network represents correlation between the tensor and the corresponding adjacent tensor of the tensor network; and
computing at least one moment of the probability distribution by processing the tensor network for sampling of the probability distribution.
